(19) United States
(12) Patent Application Publication
(10) Pub. No.: US 2020/0207669 A1
(43) Pub. Date: Jul. 2, 2020

(54) POROUS CERAMIC COMPOSITE STRUCTURE AND METHOD OF MAKING THE SAME

(71) Applicant: Hokang S.M. Co., Ltd., Hsinchu City (TW)

(72) Inventor: Hongy Lin, Missouri, MO (US)

(21) Appl. No.: 16/286,505

(22) Filed: Feb. 26, 2019

(30) Foreign Application Priority Data
Dec. 28, 2018 (TW) 107147555

(51) Int. Cl. C04B 37/00; C04B 38/00; C04B 38/02; C04B 38/06

(52) U.S. Cl. CPC C04B 37/001; C04B 38/0054; C04B 38/02; B01D 39/2075; C04B 38/067; C04B 38/0675; C04B 38/068

(57) ABSTRACT

The present invention is related to a porous ceramic composite structure with high mechanical strength and a wide range of porosity which makes flow rate of fluid highly tunable. The porous ceramic composite structure comprises a dense ceramic sheath and one or more inner porous ceramic bodies. The ceramic sheath provides good mechanical properties, protects the one or more inner porous ceramic bodies, and allows the one or more inner porous ceramic bodies to undergo a wide range of porosity changes while still maintaining excellent mechanical properties.

### CROSS-REFERENCE TO RELATED APPLICATIONS

The present invention claims the benefit of priority to Patent Application No. 107147555, filed in Taiwan on Dec. 28, 2018, which is hereby incorporated by reference in its entirety.

### FIELD

The present invention is related to a porous ceramic composite structure and a method of making the same and, more particularly, to a porous ceramic composite structure having high porosity and high mechanical strength and a method of making the same.

### BACKGROUND

There is often a need for fluid dispersion, fluid flow regulation, filtration and the like in industries such as automobile, purification, filtration and semiconductor. In the current market, a monolithic porous ceramic (for example, high-purity alumina or cordierite) sintered body is mainly used as a carrier to achieve the aforementioned functions. When such a monolithic porous ceramic sintered body is used as a carrier, the larger the porosity, pore size or pore connectivity, the more fluid that can pass through it. As a result, more fluid can be processed per unit time. However, as the porosity and pore size increase, the carrier has lower mechanical strength. Due to the mechanical strength required, the porosity and/or pore size of the carrier cannot be arbitrarily increased in order to regulate the range of fluid flow. Especially in the case where large porosity and high flow rate are required, the mechanical strength of the carrier may be too low, leading to a great limitation on application in harsh circumstance where corrosion resistance is required.

It is in this context that various embodiments of the present invention arise.

### SUMMARY

The present invention solves the aforementioned problems by providing a porous ceramic composite structure. One or more inner porous ceramic bodies in the porous ceramic composite structure have high porosity, allowing more fluid to pass therethrough. Furthermore, the inner porous ceramic bodies are supported by a ceramic sheath with high density such that the porous ceramic composite structure of the present invention can maintain good mechanical properties.

The present invention provides a porous ceramic composite structure, comprising a ceramic sheath and one or more porous ceramic bodies. The ceramic sheath comprises a pillar and one or more through-holes. The pillar comprises a top surface, a bottom surface and a sidewall. The one or more through-holes extend between the top surface and the bottom surface. The one or more porous ceramic bodies are located in the one or more through-holes of the ceramic sheath, and have a plurality of pores, which are interconnected with one another to enable fluid to pass therethrough. The ceramic sheath comprises a ceramic material having a theoretical density, and the ceramic material has a high density of between about 70% and about 99.99% of the theoretical density.

In one embodiment, in a cross section of the pillar, the cross-sectional area of the ceramic sheath occupies about 10% to about 90% of the cross-sectional area of the porous ceramic composite structure. For example, the cross section is parallel to the top surface of the pillar. The total cross-sectional area of the porous ceramic composite structure includes the cross-sectional areas of the ceramic sheath and the one or more porous ceramic bodies.

In one embodiment, the one or more porous ceramic bodies have a porosity of between about 30% and about 90%. The one or more porous ceramic bodies have a pore diameter of between about 0.1 and about 500 μm.

In one embodiment, the one or more porous ceramic bodies comprise the same ceramic material as the ceramic sheath. The ceramic material is selected from the group consisting of oxide ceramic, silicon carbide, silicon nitride, aluminum nitride and a combination thereof. The oxide ceramic may be, for example, aluminum oxide, zirconium oxide, magnesium oxide, mullite, cordierite or a combination thereof.

In one embodiment, the one or more porous ceramic bodies partly fill the one or more through-holes of the ceramic sheath, thereby forming one or more blind holes in the pillar.

The present invention also provides a method of making porous ceramic composite structure, comprising: (a) forming a composite structure green body comprising a sheath green body and one or more pore-forming green bodies, the sheath green body comprising a pillar and one or more through-holes, the one or more pore-forming green bodies are located in the one or more through-holes of the sheath green body; (b) sintering the composite structure green body; and (c) cooling to form the porous ceramic composite structure.

In one embodiment, the step (a) comprises: pressing ceramic powder into the sheath green body by a mold; mixing an additional amount of the ceramic powder with a pore former to form pore-forming powder; pressing the pore-forming powder to form the pore-forming green body; and filling the one or more through-holes of the sheath green body with the pore-forming green body to form the composite structure green body.

In another embodiment, the step (a) comprises: mixing a ceramic powder, a dispersant, a binder and a liquid to form sheath slurry; mixing an additional amount of the ceramic powder, an additional amount of the dispersant, an additional amount of the binder, an additional amount of the liquid and a pore former to form pore-forming slurry; forming a composite structure by co-extrusion of the sheath slurry and the pore-forming slurry; and drying the composite structure to form the composite structure green body. The sheath green body is formed from the sheath slurry. The one or more pore-forming green bodies are formed from the pore-forming slurry.

In one example, the pore former may be carbon powder, graphite powder or carbon-containing compound. In another example, the pore former may be a mixture of starch and hydrogen peroxide.

These and other aspects are described further below with reference to the drawings.

### BRIEF DESCRIPTION OF THE DRAWINGS

FIG. 1 is a process flow diagram showing a method of making a porous ceramic composite structure according to an embodiment of the present invention.

FIG. 2 is a schematic diagram of a porous ceramic composite structure according to an embodiment of the present invention.

FIG. 3 is a schematic diagram of a porous ceramic composite structure according to an embodiment of the present invention.

FIG. 4 is a perspective schematic diagram of a porous ceramic composite structure according to an embodiment of the present invention.

FIG. 5 is a process flow diagram showing a method of forming a composite structure green body according to an embodiment of the present invention.

FIG. 6 is a process flow diagram showing a method of forming a composite structure green body according to an embodiment of the present invention.

In the drawings, similar or the same components are designated by the same numerals.

### DETAILED DESCRIPTION

The objects, advantages and features of the present invention will become apparent from the following detailed descriptions in conjunction with the accompanying drawings.

In the following description, numerous specific details are set forth to provide a thorough understanding of the presented embodiments. The disclosed embodiments may be practiced without some or all of these specific details. In other instances, well-known structures and process operations have not been described in detail to not unnecessarily obscure the disclosed embodiments. While the present invention will be described in conjunction with the specific embodiments, it will be understood that the specific embodiments are not intended to limit the disclosed embodiments. Terms such as “above”, “below”, “top”, “bottom”, “inner”, “outer” and so forth will be used in the following description. However, these relative terms are used for ease of understanding and are not used in a limiting sense. Furthermore, the various embodiments shown in the drawings are illustrative, and are not necessarily drawn to scale.

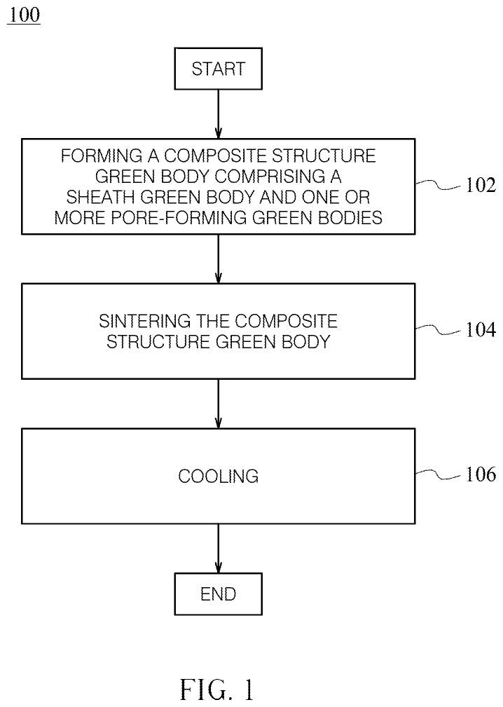

As shown in FIG. 1, the present invention provides a method 100 of preparing a porous ceramic composite structure, the steps of which are described below. First, in operation 102, a composite structure green body is formed. The composite structure green body comprises a sheath green body and one or more pore-forming green bodies. The sheath green body comprises a pillar and one or more through-holes. In one embodiment, the pillar is a cylinder having a top surface, a bottom surface and a sidewall. Alternatively, the pillar may be a polygonal pillar, such as a quadrilateral pillar, a hexagonal pillar or other suitable polygonal pillar. In one embodiment, the sheath green body has one through-hole extending between the top surface and the bottom surface of the pillar. The sheath green body may have a plurality of through-holes extending between the top surface and the bottom surface of the pillar as needed. The one or more pore-forming green bodies are located in the one or more through-holes of the sheath green body.

After the composite structure green body is formed, it is sintered in operation 104. For example, in an atmosphere containing 6 to 18% by volume of oxygen, the composite structure green body is heated at a temperature of about 500 to 900° C. to decompose pore former therein, thereby forming voids in the pore-forming green body. Next, the composite structure green body is heated, at a heating rate of 5 to 600° C. per hour, to a sintering temperature for a period of time, such as 180 minutes. The sintering temperature may be between about 1200 and 1800° C. This sintering treatment converts the sheath green body into a ceramic sheath having a high density, which serves as the main support structure of the entire porous ceramic composite structure. Further, after the sintering treatment, the pore former in the pore-forming green body is decomposed, so that a porous ceramic body can be formed. The porous ceramic body has many tiny pores that can be interconnected with one another to allow fluid to pass therethrough to achieve the functions of fluid filtration, flow regulation or the like.

Then, in operation 106, the temperature is lowered to obtain the porous ceramic composite structure of the present invention.

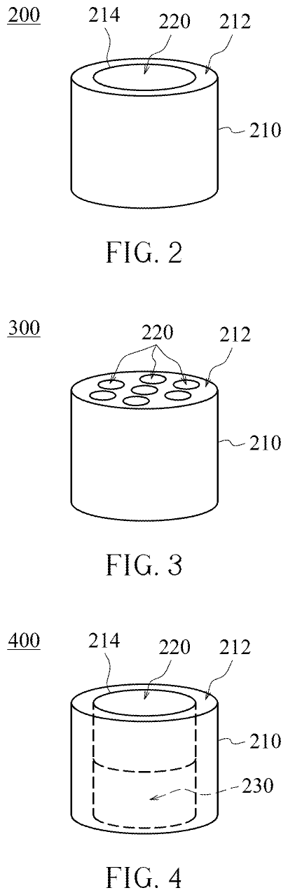

Referring to FIG. 2, a schematic diagram of a porous ceramic composite structure 200 is showed according to an embodiment of the present invention. The porous ceramic composite structure 200 includes a ceramic sheath 210 and a porous ceramic body 220, both of which are substantially composed of ceramic material but may also include a small amount of dopant therein. The ceramic sheath 210 includes a pillar 212 having a top surface, a bottom surface and a sidewall. In this embodiment, the pillar 212 is a cylinder. However, it should be understood that the pillar may have other shapes. For example, the pillar may be a polygonal pillar such as a quadrilateral pillar, a hexagonal pillar or the like. The ceramic sheath 210 also has a through-hole 214 extending between the top surface and the bottom surface. The porous ceramic body 220 is located within the through-hole 214 of the ceramic sheath 210 and has many tiny pores. For example, the porous ceramic body may have a pore diameter of between about 0.1 and about 1000 μm, but is not limited thereto. These pores are interconnected with one another, thus allowing fluid to pass through. Appropriate porosity and pore diameter can be produced for use in accordance with the fluid and flow rate to be passed.

The ceramic sheath 210 is substantially composed of ceramic material. The ceramic material may be selected from, for example, oxide ceramic, silicon carbide, silicon nitride, aluminum nitride and a combination thereof. The oxide ceramic may be selected from aluminum oxide, zirconium oxide, magnesium oxide, mullite, cordierite and a combination thereof, but is not limited thereto. In general, a ceramic material has a theoretical density. In order to provide good mechanical strength, the ceramic material in the ceramic sheath 210 has a high density of between about 70% and 99.99% of its theoretical density.

The porous ceramic body 220, having many tiny pores, is also substantially composed of ceramic material. In general, the ceramic materials of the porous ceramic body 220 and the ceramic sheath 210 have the same chemical composition but have different density. In another embodiment, the ceramic materials of the porous ceramic body and the ceramic sheath may be different. The ceramic material of the porous ceramic body 220 may be selected from, for example, oxide ceramic, silicon carbide, silicon nitride, aluminum nitride and a combination thereof. The oxide ceramic may be selected from aluminum oxide, zirconium oxide, magnesium oxide, mullite, cordierite and a combination thereof, but is not limited thereto. In one embodiment, the porous ceramic body 220 has a porosity of between about 10% and 90%. In one embodiment, the porous ceramic body 220 has a pore diameter of between about 0.1 and 1000 μm. Alternatively, the porous ceramic body has a pore diameter of between about 0.5 and 500 μm.

FIG. 3 shows a schematic diagram of a porous ceramic composite structure 300 according to another embodiment of the present invention. Similar to the porous ceramic composite structure 200 in FIG. 2, the porous ceramic composite structure 300 also includes a ceramic sheath 210. The ceramic sheath 210 in this embodiment includes a plurality of through-holes extending between the top surface and the bottom surface of the pillar 212. Porous ceramic bodies 220 are located in the plurality of through-holes. Therefore, the porous ceramic composite structure 300 includes several pillar-shaped porous ceramic bodies 220. As described above, the ceramic material of the ceramic sheath 210 has a high density and provides good mechanical strength; the plurality of porous ceramic bodies 220 have many tiny pores therein, which are interconnected with one another, thereby enabling fluid to pass therethrough. In the embodiment shown in FIG. 3, the porous ceramic composite structure 300 includes seven pillar-shaped porous ceramic bodies 220. However, one with ordinary knowledge in the art will appreciate that there may be other numbers of pillar-shaped porous ceramic bodies.

In a cross section of the pillar 212 of the porous ceramic composite structure 200 or 300, the cross-sectional area of the ceramic sheath occupies about 10% to about 90% of the entire cross-sectional area of the porous ceramic composite structure, which includes the cross-sectional areas of both of the ceramic sheath 210 and the one or more porous ceramic bodies 220.

In the porous ceramic composite structure 200 shown in FIG. 2, the porous ceramic body 220 may substantially fully fill the through-hole 214 of the ceramic sheath 210. That is, the top surface of the ceramic sheath 210 is substantially coplanar with the top surface of the porous ceramic body 220, and the bottom surface of the ceramic sheath 210 is substantially coplanar with the bottom surface of the porous ceramic body 220. In another embodiment, the porous ceramic body 220 partly fills the through-hole 214 of the ceramic sheath 210, thereby forming a blind hole in the pillar 212.

FIG. 4 shows a perspective schematic view of a porous ceramic composite structure 400 including a ceramic sheath 210 and a porous ceramic body 220, in accordance with an embodiment of the present invention. The porous ceramic composite structure 400 in FIG. 4 is similar to the porous ceramic composite structure 200 in FIG. 2. However, in this embodiment, the porous ceramic body 220 partly fills the through-hole 214 of the ceramic sheath 210, thereby forming a blind hole 230 in the pillar 212. The blind hole can be used to provide more clearance for more fluid flow. In the porous ceramic composite structure 300 in FIG. 3, the porous ceramic bodies 220 may substantially fully fill the through-holes of the ceramic sheath 210. In another embodiment, the porous ceramic bodies 220 may not fully fill the through-holes of the ceramic sheath 210, forming a plurality of blind holes in the pillar.

Returning to FIG. 1, the method 100 of making a porous ceramic composite structure according to the present invention comprises forming a composite structure green body first, sintering the composite structure green body and then performing cooling, thereby obtaining the porous ceramic composite structure of the present invention.

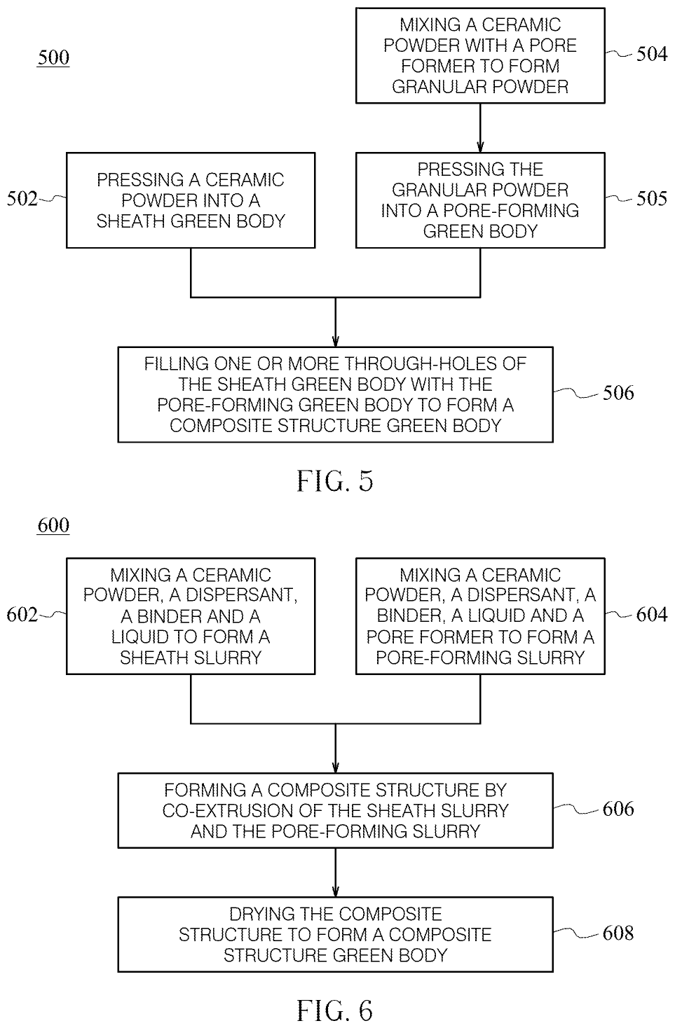

FIG. 5 shows a flow diagram of a method 500 for forming a composite structure green body in accordance with an embodiment of the present invention. In operation 502, a mold is used to press ceramic powder into a sheath green body, which comprises a pillar and one or more through-holes. The ceramic powder used to form the sheath green body may be selected from oxides (for example, aluminum oxide, zirconium oxide and magnesium oxide), silicon nitride, aluminum nitride, silicon carbide and a combination thereof.

In operation 504, ceramic powder is mixed with a pore former to form granular powder. The ceramic powder used to form the granular powder may be selected from oxides (for example, aluminum oxide, zirconium oxide and magnesium oxide), silicon nitride, aluminum nitride, silicon carbide and a combination thereof. In one embodiment, the ceramic powder used to form the sheath green body may be different from the ceramic powder used to form the granular powder. In another embodiment, the ceramic powder used to form the sheath green body is the same as the ceramic powder used to form the granular powder. The pore former may be selected from carbon powder, graphite powder and a carbon-containing compound. The carbon-containing compound may be a carbon-containing organic compound such as flour, petroleum coke, starch, carbon black, foamable resin, foam resin, poly(methyl methacrylate) (PMMA), polystyrene (PS), poly(ethylene terephthalate) and a combination thereof. Alternatively, the pore former can be a mixture of starch and hydrogen peroxide. In other embodiments, the ceramic powder used to form the sheath green body and the ceramic powder used to form the granular powder may be mixed with other chemical additives such as dispersant, release agent, binder or plasticizer.

In one embodiment, in operation 504, after the ceramic powder is mixed with the pore former, a liquid may be added and the mixture is stirred to form slurry. The slurry is dried to form the granular powder. Then, in operation 505, the granular powder is pressed to form a pore-forming green body.

In another embodiment, in operation 504, after the slurry is dried to form the granular powder, the granular powder is not pressed. Instead, in the next operation 506, the granular powder is filled into the sheath green body, and then the granular powder is pressed and shaped.

While operation 502 is described first and operations 504 and 505 are described next in the foregoing, it should be understood that the order of these operations is not limited thereto. Operations 504 and 505 may be performed first, followed by operation 502. Alternatively, operation 502 and operations 504 and 505 can be performed simultaneously.

Next, in operation 506, the pore-forming green body is filled into the one or more through-holes of the sheath green body, and then pressure is applied thereto so that the outer periphery of the pore-forming green body makes close contact with the inner periphery of the sheath green body, thereby obtaining a composite structure green body. After the pore-forming green body is filled and the pressure is applied, the pore-forming green body may fully fill the one or more through-holes of the sheath green body. Alternatively, the pore-forming green body may not fully fill the one or more through-holes of the sheath green body so as to form one or more blind holes (such as the blind hole 230 shown in FIG. 4) in a porous ceramic composite structure formed after sintering.

FIG. 6 shows a flow diagram of a method 600 for forming a composite structure green body in accordance with another embodiment of the present invention. In operation 602, ceramic powder, a dispersant, a binder and a liquid are mixed to form sheath slurry. In operation 604, ceramic powder, a dispersant, a binder, a pore former and a liquid are mixed to form pore-forming slurry. While operation 602 is described first and operation 604 is described next in the foregoing, it should be understood that the order of the two operations is not limited thereto. Operation 604 may be performed first, followed by operation 602. Alternatively, operation 602 and operation 604 can be performed simultaneously.

In one embodiment, the ceramic powder used to form the sheath slurry may be different from the ceramic powder used to form the pore-forming slurry. In another embodiment, the ceramic powder used to form the sheath slurry is the same as the ceramic powder used to form the pore-forming slurry. Any suitable ceramic powder and pore former can be used, such as the ceramic powder and pore former described above. The dispersant may be polyvinyl alcohol. The binder may be selected from sodium hydroxymethylcellulose, hydroxymethylcellulose, polyvinyl alcohol and a combination thereof. The liquid may be selected from various suitable solvents, such as water and ethanol.

Referring to FIG. 6 again, in operation 606, a composite structure is formed by co-extrusion of the sheath slurry and the pore-forming slurry. In operation 608, the composite structure is dried to obtain a composite structural green body comprising a sheath green body and one or more pore-forming green bodies. The sheath green body is derived from the sheath slurry, and the one or more pore-forming green bodies are derived from the pore-forming slurry. After the composite structure green body is formed, the porous ceramic composite structure of the present invention can be prepared by the method shown in FIG. 1.

The porous ceramic composite structure of the present invention has a high-density ceramic sheath as a main support structure, making the whole porous ceramic composite structure have good mechanical properties. Since the ceramic sheath can support the inner porous ceramic body, the porosity, pore size, pore connectivity, etc. of the porous ceramic body can be adjusted as needed to regulate the range of fluid flow without being limited by the mechanical strength required.

Although the foregoing embodiments have been described in some detail for purposes of clarity of understanding, it will be apparent that certain changes and modifications may be practiced within the scope of the appended claims. It should be noted that there are many alternative ways of implementing the methods and structures of the present embodiments. Accordingly, the present embodiments are to be considered as illustrative and not restrictive, and the present invention is not to be limited to the details given herein.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the foregoing processes may be changed.

The subject matter of the present disclosure includes all novel and nonobvious combinations and sub-combinations of the various processes and configurations, and other features, functions, acts, and/or properties disclosed herein, as well as any and all equivalents thereof.

What is claimed is:

1. A porous ceramic composite structure, comprising:
a ceramic sheath, comprising a pillar and one or more through-holes, the pillar comprising a top surface, a bottom surface and a sidewall, the one or more through-holes extending between the top surface and the bottom surface; and
one or more porous ceramic bodies, located in the one or more through-holes of the ceramic sheath, the one or more porous ceramic bodies having pores, the pores interconnected with one another to enable fluid to pass therethrough,
wherein the ceramic sheath comprises a ceramic material having a theoretical density, and the ceramic material has a high density of between about 70% and about 99.99% of the theoretical density.

2. The porous ceramic composite structure of claim 1, wherein in a cross section of the pillar, the cross-sectional area of the ceramic sheath occupies about 10% to about 90% of the cross-sectional area of the porous ceramic composite structure.

3. The porous ceramic composite structure of claim 1, wherein the one or more porous ceramic bodies have a porosity of between about 30% and about 90%.

4. The porous ceramic composite structure of claim 1, wherein the one or more porous ceramic bodies have a pore diameter of between about 0.1 and about 500 μm.

5. The porous ceramic composite structure of claim 1, wherein the one or more porous ceramic bodies comprise the ceramic material.

6. The porous ceramic composite structure of claim 1, wherein the ceramic material is selected from the group consisting of oxide ceramic, silicon carbide, silicon nitride, aluminum nitride and a combination thereof.

7. The porous ceramic composite structure of claim 5, wherein the ceramic material is selected from the group consisting of oxide ceramic, silicon carbide, silicon nitride, aluminum nitride and a combination thereof.

8. The porous ceramic composite structure of claim 6, wherein the oxide ceramic is selected from the group consisting of aluminum oxide, zirconium oxide, magnesium oxide, mullite, cordierite and a combination thereof.

9. The porous ceramic composite structure of claim 7, wherein the oxide ceramic is selected from the group consisting of aluminum oxide, zirconium oxide, magnesium oxide, mullite, cordierite and a combination thereof.

10. The porous ceramic composite structure of claim 1, wherein the one or more porous ceramic bodies partly fill the one or more through-holes of the ceramic sheath, thereby forming one or more blind holes.

11. A method of making porous ceramic composite structure, comprising:
forming a composite structure green body comprising a sheath green body and one or more pore-forming green bodies, the sheath green body comprising a pillar and one or more through-holes, the one or more pore-forming green bodies are located in the one or more through-holes of the sheath green body; and
sintering the composite structure green body to form the porous ceramic composite structure.

12. The method of making porous ceramic composite structure of claim 11, wherein the step of forming a composite structure green body comprises:
pressing a ceramic powder into the sheath green body by a mold;
mixing an additional amount of the ceramic powder with a pore former to form a pore-forming powder;
pressing the pore-forming powder to form the one or more pore-forming green bodies; and
filling the one or more through-holes of the sheath green body with the one or more pore-forming green bodies to form the composite structure green body.

13. The method of making porous ceramic composite structure of claim 11, wherein the step of forming a composite structure green body comprises:
mixing a ceramic powder, a dispersant, a binder and a liquid to form a sheath slurry;
mixing an additional amount of the ceramic powder, an additional amount of the dispersant, an additional amount of the binder, an additional amount of the liquid and a pore former to form a pore-forming slurry;
forming a composite structure by co-extrusion of the sheath slurry and the pore-forming slurry; and
drying the composite structure to form the composite structure green body, wherein the sheath green body is formed from the sheath slurry, and the one or more pore-forming green bodies are formed from the pore-forming slurry.

14. The method of making porous ceramic composite structure of claim 11, wherein the step of forming a composite structure green body comprises:
pressing a ceramic powder into the sheath green body by a mold;
mixing an additional amount of the ceramic powder with a pore former to form a pore-forming powder; and
filling the one or more through-holes of the sheath green body with the pore-forming powder to form the composite structure green body.

15. The method of making porous ceramic composite structure of claim 12, wherein the pore former is selected from the group consisting of carbon powder, graphite powder, a carbon-containing compound and a mixture of starch and hydrogen peroxide.

16. The method of making porous ceramic composite structure of claim 13, wherein the pore former is selected from the group consisting of carbon powder, graphite powder, a carbon-containing compound and a mixture of starch and hydrogen peroxide.

17. The method of making porous ceramic composite structure of claim 14, wherein the pore former is selected from the group consisting of carbon powder, graphite powder, a carbon-containing compound and a mixture of starch and hydrogen peroxide.

18. The method of making porous ceramic composite structure of claim 15, wherein the carbon-containing compound is selected from the group consisting of flour, petroleum coke, starch, carbon black, foamable resin, foam resin, poly(methyl methacrylate) (PMMA), polystyrene (PS), poly(ethylene terephthalate) and a combination thereof.

19. The method of making porous ceramic composite structure of claim 16, wherein the carbon-containing compound is selected from the group consisting of flour, petroleum coke, starch, carbon black, foamable resin, foam resin, poly(methyl methacrylate) (PMMA), polystyrene (PS), poly(ethylene terephthalate) and a combination thereof.

20. The method of making porous ceramic composite structure of claim 17, wherein the carbon-containing compound is selected from the group consisting of flour, petroleum coke, starch, carbon black, foamable resin, foam resin, poly(methyl methacrylate) (PMMA), polystyrene (PS), poly(ethylene terephthalate) and a combination thereof.
